(19) United States
(12) Patent Application Publication
(10) Pub. No.: US 2003/0225612 A1
(43) Pub. Date: Dec. 4, 2003

(54) Method and system for implementing security in the travel industry

(75) Inventors: Russell Alan DeSimone, Marietta, GA (US); Scott Paul Gosline, Duluth, GA (US); Kevin Murphy, Peachtree City, GA (US); Patrick Carl Rary, Marietta, GA (US); Tommy D. Odom, Newnan, GA (US); Robert A. Maruster, Marietta, GA (US)

Correspondence Address: Robert T. Neufeld, Esq., KING & SPALDING LLP, 45th Floor, 191 Peachtree Street, N.E., Atlanta, GA, 30303, US

(73) Assignee: Delta Air Lines, Inc.

(21) Appl. No.: 10/366,113

(22) Filed: Feb. 12, 2003

Related U.S. Application Data
(60) Provisional application No. 60/364,252, filed on Mar. 14, 2002.
(60) Provisional application No. 60/356,409, filed on Feb. 12, 2002.

(51) Int. Cl. G06F 17/60

(52) U.S. Cl. 705/13; 705/4; 340/573.1

(57) ABSTRACT

Computer-implemented security for the travel industry. Travel industry systems can supply passenger, employee, and cargo data to a risk assessment engine that services the travel industry. The risk assessment engine collects data from throughout the travel industry and combines it with data from other government and commercial sources. The risk assessment engine uses the collected data to compute a score that quantifies the potential risk posed by a particular person or package. The score can be used by a variety of systems in the travel industry to adjust a level for screening people and packages that enter a secure travel system. A more comprehensive and accurate scoring system allows the travel industry to conduct more intelligent and efficient screening of people and packages that enter the secure travel system.

### RELATED APPLICATIONS

This patent application claims priority to and incorporates by reference U.S. provisional patent application entitled “Method and System for Implementing Security in the Travel Industry”, filed Feb. 12, 2002, and assigned serial No. 60/356,409.

### TECHNICAL FIELD

The present invention is generally directed to managing security in the travel industry. More specifically, the present invention provides a system and method that supports connecting disparate travel industry systems and components into a unified security system.

### BACKGROUND OF THE INVENTION

As the number of people that travel for business and personal reasons generally continues to increase, the safety and security of passengers continues to be an important issue for carriers, governments, and the general public. Security in the modern travel industry first garnered significant attention in the 1970s with the hijacking of several commercial passenger airplanes. For instance, in 1973, a series of flights were hijacked to Cuba. Many of the advances and improvements in travel security have been centered around the airline industry, but have applicability to the entire travel industry. For example, in an attempt to prevent passengers from carrying un-permitted guns onto aircraft, the Federal Aviation Administration (FAA) required that all passengers be screened prior to boarding using metal detectors. Later, X-ray technology was added at airports to allow screeners to examine carry-on luggage more thoroughly. These techniques were reasonably effective in preventing hijackings in which a passenger carrying a weapon attempted to divert a flight en route.

However, security problems in the travel industry, and particularly in the air travel sector, persisted. Screening of passengers proved ineffective against terrorists whose goal was not to hijack the aircraft, but rather to destroy it in flight by means of explosives. The bombing of Pan Am flight 103 in 1988 expanded the need for security to include an explosive detection system (EDS) capable of detecting plastic explosives. The best technology available in 1988 was inadequate for this task, leading to the development of a device by InVision, a company based in Foster City, Calif., that functions similarly to a CAT Scan. Other similar detection machines have since been produced by other manufacturers.

Before 2002, airlines were responsible for screening passengers and their luggage and they usually contracted with private security companies to handle these tasks. During 2002, responsibility for screening was shifted to the Transportation Security Administration (TSA).

After Sep. 11, 2001, the FAA required that more stringent procedures be put in place, including random physical searches of passengers and carry-on luggage, positive passenger-bag matching (no bag may be loaded on an aircraft unless the owner of the bag is also on board), and screening of all checked baggage.

Both passenger and baggage screening are ultimately dependent upon human supervision. There are numerous weaknesses inherent in dependence upon manual screening, including:

Limitations of the technology (inability to recognize or react to all weapons, explosives, etc.)

Inadequate training of screeners

High turnover rate of screeners

Inattentiveness of screeners due to fatigue

Time pressures due to high volume of passengers and bags to be screened

As early as the mid-1990s, both the airlines and aviation security experts realized that the existing security systems would become unmanageable as the number of people traveling increased. Considering that over one billion persons are processed through security checkpoints every year, the industry quickly began to realize that this was like looking for a needle in a haystack. To make security more manageable and effective, security experts realized that they needed to filter the total number of passengers to a smaller subset that would be the focus of greater security scrutiny.

On May 7, 1997 the FAA implemented the Computer Assisted Passenger Pre-Screening (CAPPS) system. CAPPS was designed to make the needle (threat) easier to find. It does this by applying certain criteria to passenger records and assigning a score that quantifies the risk the passenger presents. The CAPPS scoring system allows security personnel to eliminate persons thought not to be a threat to the flight and reduce the total number of passengers that need to be further scrutinized. The remaining passengers, while not necessarily suspect, can be directed to other procedures, such as direct questioning or hand-searching of luggage, to clear them prior to travel or take them into custody, if necessary.

Initially, the risk assessment scores returned were used only relative to checked baggage in an attempt to circumvent introduction of explosives into the hold of the aircraft. If a passenger's score indicated the possibility of higher than normal risk, that passenger's bags were searched, but not the passenger. Any passenger who had not checked bags was not given extra scrutiny, even if CAPPS indicated a potential threat.

The CAPPS system runs in each airline's computer system, making simple data analysis easy to perform. The CAPPS system is currently managed by the Transportation Safety Authority (TSA), which establishes various weights for the scoring criteria. The original CAPPS system, as implemented by the FAA, had a number of obvious shortcomings. Because it called for the computer code for the CAPPS risk assessment engine (RAE) to reside within each airline's departure control system, each RAE relied solely upon data collected by the individual airline. This data usually includes minimal personally identifying information (PII), such as last name and first initial, and recent booking behavior. This limitation caused the CAPPS engine to be, in effect, “blind” to suspicious booking behaviors across carriers and unable to take advantage of additional information about an individual that may have been available from other sources.

Any updates to the CAPPS software, such as new data or changes to scoring rules, were unwieldy and slow. Implementations of CAPPS within the different airlines' systems necessarily varied, due to differences in how data is collected and distributed, data formats, etc. and due to the fact that each airline had to receive the updates and make the necessary code changes individually. These different implementations cause the individual RAEs to produce inconsistent results.

After Sep. 11, 2001, a Watch List was added to the system. Passenger names could be checked against the Watch List, allowing for rapid identification of known high-risk individuals. A weakness of this system is the difficulty in identifying, with certainty, that the John Doe booked on a flight is in fact the same John Doe whose name appears on the Watch List. Updating the Watch List requires manual intervention by airline personnel, resulting in potential delays and inconsistencies in implementation.

In response to the Sep. 11, 2001 terrorist attacks, the Department of Transportation Airport Security Rapid Response team published recommendations including the establishment of a nationwide program of voluntary pre-screening of passengers, together with the issuance of “smart” credentials, to facilitate expedited processing of the vast majority of air travelers and to enable security professionals to focus their resources more effectively. The team's report encouraged the use of new technology to identify passengers and employees quickly and accurately, and to track the location and status of individuals and baggage in the airport and along the travel ribbon.

Despite the improvements in travel security adopted in response to the Sep. 11, 2001 terrorist attacks, there are still many shortcomings with the current approach to security. For example, the inability of carriers, travel agents, and other travel systems to communicate and share data limits the effectiveness of current security systems. A travel security system should also use data from a variety of sources outside the travel industry in assessing the risk that a person or piece of cargo presents.

Conventional travel security is also limited in that it does not approach security from a systemic perspective. That is, the travel system must be viewed as an access point for a variety of people and items including passengers, travel industry employees, baggage, and cargo. As used herein, the term “travel system” refers to these various people and items and the different avenues in which these people and items access modes of transportation. For example, in the airline industry, the travel system encompasses not only the airport terminal where passengers check in, but also the access points to the terminal for employees and the cargo that is shipped on planes. In the case of the airline industry in particular, in order to function profitably while supporting a high standard of security, more information needs to be more rapidly available throughout the travel system. Positive authentication of passengers, employees, shippers, etc. must be performed with speed and accuracy. Scoring of an authenticated individual must be able to occur virtually instantaneously in order to be effective in assessing passengers who did not pre-book. Score results must be pushed in real-time on a publish/subscribe basis to all who need them, so that receipt is not delayed by the necessity of requesting data and waiting for a reply.

In order to avoid communication delays or errors, the system should automatically send security alerts to at least the following:

The Federal Security Director in the airport

Federal Air Marshals and schedulers

Concourse security

Airline Corporate Security

Control of employee access to secure areas must also be based on real-time data, so that employees are not kept out of or delayed in entering areas appropriate for their job, nor allowed to enter areas for which they do not have clearance.

Finally, the system should also provide a means for gathering data beyond a risk score. Data about an individual that may assist in determining the best course of action should be accessible to law enforcement, airport security, and Corporate Security (the security clearance of the researcher will necessarily determine the content they may examine).

Accordingly, there is a need for a system-wide method for implementing security across the entire travel industry. Specifically, there is a need for a centralized system that can collect data about a passenger from a variety of sources and quantify the potential threat that the passenger poses. By quantifying the potential risk a passenger poses, the number of passengers that need to be closely scrutinized can be reduced to a more manageable volume. Centralizing the process allows for a more complete and uniform assessment of the risk the passenger presents across the entire travel industry. There is a need to use the passenger's risk score throughout the travel process including checking-in, screening of the passenger, and screening of the passenger's baggage. There is a further need to also apply risk assessment data to screening cargo shipped through the travel industry and to screen the employees that work in the travel industry. Finally, there is a need to make the risk assessment data available for use by security personnel to manage the security processes and respond to security issues.

### SUMMARY OF THE INVENTION

The present invention is generally directed to a distributed computing system that supports implementing a security system at a transportation terminal. The present invention improves upon existing approaches to travel security by using a risk assessment score throughout the travel process. The risk assessment score can be formulated prior to a passenger's travel date and can be used to minimize the security scrutiny many passengers are subjected to. The risk assessment score can also be updated or calculated on the day of travel for the passenger. In addition to scoring passengers, a risk assessment score can be calculated for screening baggage, cargo, and employees in the travel industry. By applying the risk assessment score throughout the various access points in a travel terminal, security personnel can more efficiently and effectively manage security throughout the travel process.

In one aspect, the present invention comprises a method for implementing security across the travel industry. A travel system, such as a carrier's computer systems, sends a request for a security evaluation of a passenger to a central system. The central system, as opposed to an individual carrier's system, utilizes data about the passenger from a variety of sources to perform a risk assessment. The risk assessment produces a score for the passenger that a carrier or security personnel can use to manage security for the passenger. If the passenger's score indicates a high risk, the carrier or security personnel can scrutinize the passenger more closely during the check-in and screening processes. The baggage screening system can also use the passenger's score in deciding how to screen the passenger's baggage.

In another aspect, the present invention comprises a method for managing the security of cargo shipped through the travel industry. The carrier that is shipping the cargo can send data identifying the cargo to a risk assessment system. The risk assessment system uses the identifying data and any other available data to assess the risk of the cargo. For example, the risk assessment system may also access a list of registered shippers that have been pre-approved for sending cargo. The risk assessment system provides a score quantifying the assessed risk to a cargo system that screens the cargo. The cargo system can adjust the level of scrutiny for the cargo based on the score it receives.

In yet another aspect, the present invention comprises a method for managing the security of employees working in the travel industry. A risk assessment system can receive identifying data for an employee from one of several human resource systems. Examples of employers that may transmit employee data to the risk assessment system are a food service provider, a mechanical services company, or a carrier. The risk assessment system can gather additional information about the employee from other data sources such as law enforcement databases, registered employee programs, and commercial credit services. Once the risk assessment system calculates a score for the employee indicating the potential threat the employee presents, the score is sent to an access control system. The access control system authenticates the employee and can decide whether to grant the employee access to a secure travel area based on the score. The risk assessment system can also distribute the score to security personnel.

In yet another aspect, the present invention comprises a computer-implemented system for supporting security in the travel industry. The invention comprises one or more travel systems that supply passenger travel data to a data interface. The data interface can convert the various pieces of passenger travel data to a uniform format for use by a risk assessment engine. The risk assessment engine can collect data for a passenger from a variety of sources and calculate a score for the passenger. Travel carriers and security personnel can use the score to more effectively manage the check-in process for a passenger. A physical authentication system, a security checkpoint system, and a baggage control system, among others, can use the score to determine the level of scrutiny to apply to a particular passenger. The risk assessment engine can also provide passenger scores and information to security personnel interfaces and systems for managing travel security. In addition to passenger scores, the risk assessment engine can calculate risk for cargo passing through the travel system or employees working in the travel industry. These risk scores can be used to control the access and flow of employees and cargo to and from secure areas within the travel system.

These and other aspects of the invention will be described below in connection with the drawing set and the appended specification and claim set.

### BRIEF DESCRIPTION OF THE DRAWINGS

FIG. 1 is a functional block diagram illustrating the architecture of a distributed computing network in accordance with an exemplary embodiment of the present invention.

FIG. 2 is a functional block diagram illustrating the architecture of a distributed computing network in accordance with an exemplary embodiment of the present invention applied to the airline industry.

FIG. 3 is a logic flow diagram illustrating a high-level process for implementing security in a travel process in accordance with an exemplary embodiment of the present invention.

FIG. 4 is a logic flow diagram illustrating an exemplary process for performing a pre-travel security evaluation using one embodiment of the present invention.

FIG. 5 is a logic flow diagram illustrating an exemplary process for checking in a passenger using a security evaluation in accordance with one embodiment of the present invention.

FIG. 6 is a logic flow diagram illustrating an exemplary process for screening cargo according to one embodiment of the present invention.

FIG. 7 is a logic flow diagram illustrating an exemplary process for screening employees according to one embodiment of the present invention.

### DETAILED DESCRIPTION OF THE EXEMPLARY EMBODIMENTS

The present invention provides a method and system that supports an industry-wide security system for travel. Specifically, one exemplary embodiment collects data for an individual from a variety of sources and calculates a risk assessment. Risk assessment data for many passengers can be used to prioritize threats and reduce the volume of passengers that need to be carefully scrutinized during the check-in process. Another exemplary embodiment uses risk assessment data to manage and screen travel industry employees. Yet another embodiment uses risk assessment data to screen baggage and cargo moving through the travel system. Calculating risk assessments in advance of travel allows security personnel to eliminate minor threats and make more effective use of limited screening resources. By making more informed screening decisions, security personnel can also simplify the check-in process for passengers that do not pose a significant risk.

A representative embodiment of the present invention is described herein in the context of air travel and a commercial air carrier. It should be understood that air transportation is only one exemplary embodiment of the invention concept and that additional embodiments of the invention can be used to support other modes of transportation, such as by train, bus, or ship. Furthermore, those skilled in the art will appreciate that the invention is designed to function across the entire travel industry and is not limited to one particular mode of travel. The invention also has applications beyond the transportation industry where tracking of large volumes of people or items is performed. For example, the invention could be implemented to manage security for the passage of large volumes of people through a common area, including in an amusement park, a stadium, or a multiplex theater. The invention can also be implemented in the shipping industry for managing the security of cargo and packages.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations in a distributed computing environment by conventional computer components, including remote computers, local computers, local or remote memory storage devices, display devices and input devices. Each of these conventional distributed computing components is accessible by a processing unit via a communications network.

The processes and operations performed by the distributed computing environment include the manipulation of signals by a local processing unit or a remote computer and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention can be implemented by one or more computer programs which embody the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text, for example. Therefore, disclosure of a particular set of program code instructions is not considered necessary for an adequate understanding of how to make and use the invention. The inventive functionality of the exemplary computer program(s) will be explained in more detail in the following description in conjunction with the figures illustrating the program flow.

Referring now to the drawings, in which like numerals represent like elements throughout the several figures, aspects of the present invention and an exemplary operating environment will be described.

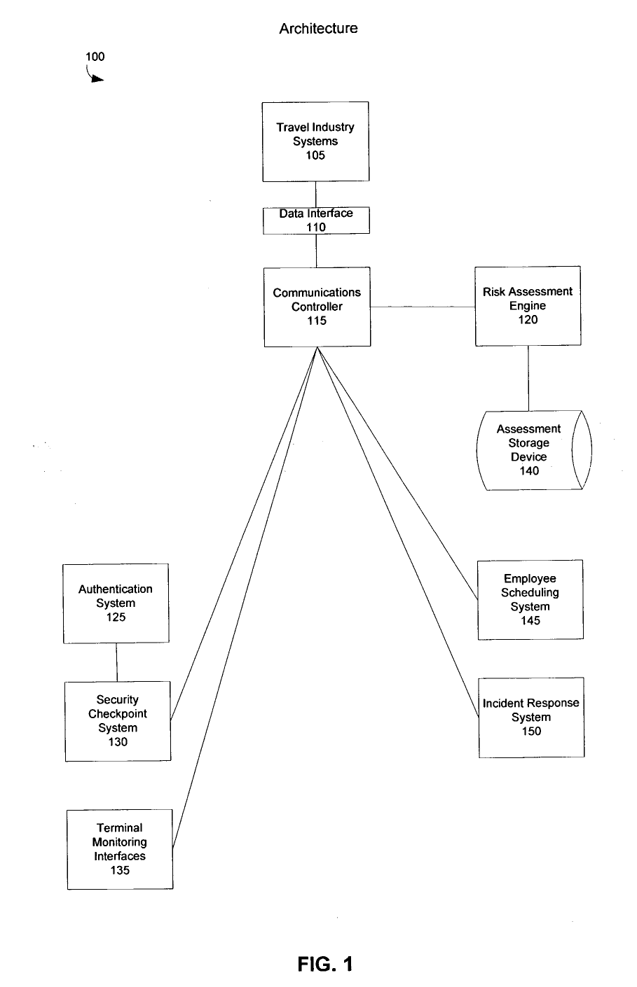

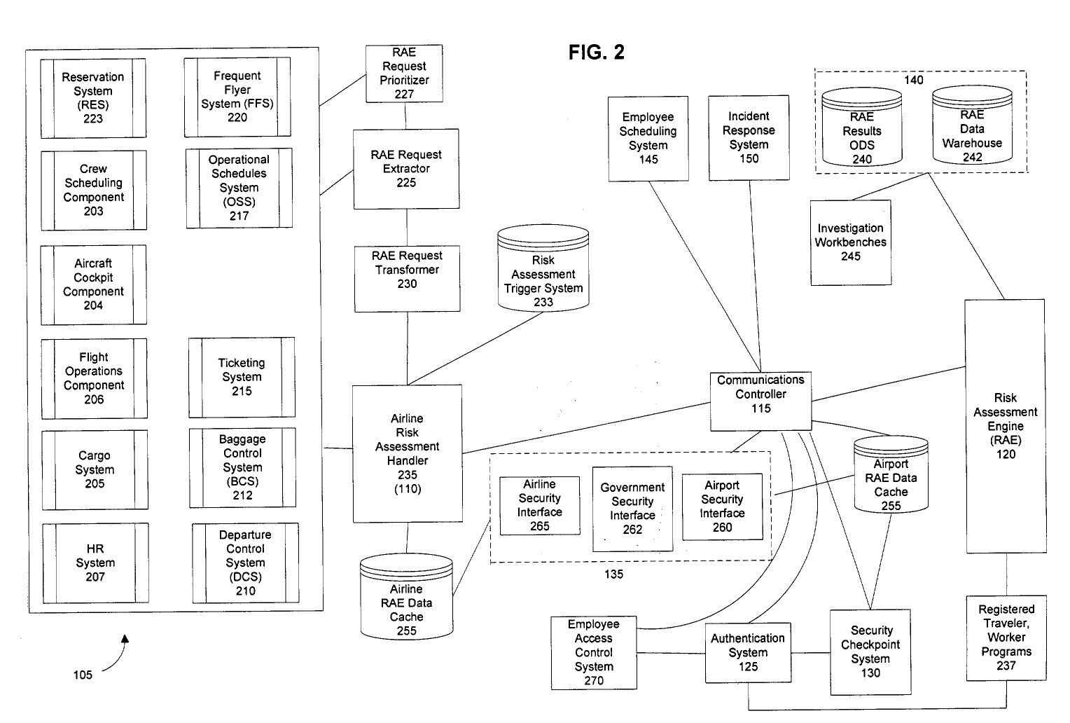

FIGS. 1 and 2 illustrate various aspects of an exemplary computing environment in which the present invention is designed to operate. Those skilled in the art will appreciate that FIGS. 1 and 2 and the associated discussion are intended to provide a brief, general description of the preferred computer hardware and program modules, and that additional information is readily available in the appropriate programming manuals, user's guides, and similar publications.

Referring to FIG. 1, an architecture 100 for supporting the operation of an exemplary embodiment of the present invention for implementing security in the travel industry is illustrated. In FIG. 1, a travel industry system 105 is linked to a risk assessment engine 120 through a data interface 110 and a communications controller 115. The travel industry system 105 represents any one of a variety of computing systems or data sources in the travel industry that contains data for computing a risk assessment. For example, the travel industry system 105 could be a reservation system for a travel agency, an employee scheduling system for a freight shipping company, or a passenger data system for an air carrier. The risk assessment engine 120 is typically a centralized system used to assess risk for people and items passing through the travel system. An example of a conventional assessment engine is the CAPPS system described above. The risk assessment engine 120 is centralized so that it can collect and compare data from a variety of sources in determining a potential risk and share the results of that determination with the other systems throughout the travel industry. At the time of this application filing, an exemplary risk assessment engine is being assembled by the TSA for use in travel security. The TSA risk assessment engine will collect data from a variety of sources including multiple travel carriers, travel reservation systems, government data sources that include law enforcement and immigration records, and commercial credit services. The risk assessment engine 120 uses the various pieces of data to calculate a score for the person or item entering the travel system. An assessment storage device 140 can store the scores for further refinement and updating of scores in the future.

It should be understood by those skilled in the art that the “score” can comprise a variety of data related to the potential risk that a person or piece of baggage or cargo represents to the secure travel area. For example, in one embodiment the score is a numerical value quantifying the risk presented by certain data. In another embodiment, the score can comprise a numerical value as well as particular instructions on how a person or piece of cargo should be screened. In yet another embodiment, the score includes information about whether a person is identified on a “watch list.” The information contained in the score can be customized depending on the needs of the different travel industries and systems. Scores can also be aggregated to assess particular flights or airports, for example.

As illustrated in FIG. 1, a communications controller 115 can share a score calculated by the risk assessment engine 120 with a variety of systems that support managing security in the travel industry. The communications controller 115 can transmit score requests and calculated scores in real-time to the various components using synchronous or asynchronous delivery mechanisms. A dynamic publish and subscription mechanism represents the preferred method for controlling communications. In one embodiment, a security checkpoint system 130 can receive the risk assessment engine score. A security checkpoint system 130 is typically a distinct system for screening a person and his or her personal items. In some instances, the security checkpoint system 130 and the authentication system 125 can be combined into a single system. The security checkpoint system 130 comprises a system for reading a person's identity and retrieving that person's score, as well as screening and scanning devices for detecting banned items located on the person or in their personal items. The security checkpoint system 130 ascertains the person's identity from a boarding document or other piece of identification, such as a passport, driver's license, or registered passenger card. Physical authentication can occur using the piece of identification and, in the case of a registered passenger, using biometrics.

The security checkpoint system 130 also retrieves the person's score from the risk assessment engine 120 via the communications controller 115. If the person's score indicates a high degree of risk, she can be directed to a checkpoint process with greater scrutiny. Checkpoint processes with greater scrutiny can include physical searches of baggage and the person by security personnel. If the person has a score with a low degree of risk, or is enrolled in a registered traveler or employee program, she can be directed to an expedited checkpoint process. Once the person clears the checkpoint, the security checkpoint system 130 updates the person's records and publishes the update to other subscribing systems, such as the travel industry systems 105 and the terminal monitoring interfaces 135.

As indicated above, the authentication system 125 typically functions in conjunction with the security checkpoint system 130. A representative authentication system 125 can include both a biometric authentication, such as a fingerprint scan, retinal scan, or facial scan, and an electronic key, such as PKI technology held in a smart card or magnetic strip card. The authentication system 125 takes a biometric sample and compares it to a previously stored sample that is retrieved using the electronic key. If the samples match and the person satisfies the security checkpoint system 130, the employee or passenger is allowed to proceed into the secure travel system. The biometric scan technology is particularly useful for expediting the authentication of people enrolled in a registered traveler or employee program. For those persons not registered, other means of authentication can be employed, such as techniques that scan a person's identifying documents.

The authentication system 125 can also provide feedback to the risk assessment engine 120. For example, an employee or passenger's risk assessment may change based on the type of identifying document used by that person to gain access to the secure travel system. Authentication systems 125 can be located throughout the travel system to control which persons are permitted to access secure areas.

As illustrated in FIG. 2, the physical authentication system 125 is typically separated into a passenger authentication system 273 and an employee access control system 270 because passengers and employees generally enter different areas of a terminal. The employee access control system 270 can use a registered employee list to assist in identifying approved employees. The airport security interface 260 can receive a notification from the employee access control system 270 if an unauthorized access is attempted.

The terminal monitoring interfaces 135 also receive scores from the risk assessment engine 120 via the communications controller 115. The terminal monitoring interfaces 135 can comprise several systems used by security personnel to monitor the secure travel system. For example, the terminal monitoring interfaces 135 can be used to track the movements of persons with scores that indicate a high degree of risk. The terminal monitoring interfaces 135 can also provide additional input regarding the security records of a person. The terminal monitoring interfaces 135 can work with the incident response system 150 in the event of a security problem. The incident response system 150 supports the use of predetermined response plans that include notification requirements and manages transmission of communications between security personnel and response teams. The incident response system 150 typically comprises a software module and database to manage and store the predetermined response plans. Response teams can include terminal security, carrier personnel, and federal and local law enforcement officials. The incident response system 150 typically supports secure wireless communications between these different groups of people. In the preferred embodiment the incident response system 150 also includes an aircraft communications component to share information with the flight crew. For example, the aircraft communications component could be used in the event that a high risk passenger is not identified until after he has boarded an aircraft.

Lastly, the risk assessment engine 120 can distribute scores to an employee scheduling system 145. The employee scheduling system 145 is responsible for optimizing the use of valuable security personnel at the terminal. In the preferred embodiment, the employee scheduling system 145 represents several different scheduling systems operable for scheduling law enforcement officers, security personnel, and employees such as screeners. The employee scheduling system 145 can use the data from the risk assessment engine to determine how many people will be attempting to enter the secure travel system at a particular time and what percentage of those people present a high risk. The employee scheduling system 145 can also subscribe to data from travel industry systems 105 to ascertain the volume of people and the number of security personnel needed on a particular day.

FIG. 2 illustrates an exemplary embodiment of the present invention as applied to the airline industry. FIG. 2 sets forth many of the components from FIG. 1, but provides greater detail as to how these components are configured. Those skilled in the art will appreciate that FIG. 2 is a representation and that other embodiments of the present invention may configure the components shown in FIG. 2 in different arrangements or may omit or add certain components. The generic travel industry system 105 is shown with various systems that an airline typically employs. Although not shown in FIG. 2, it is understood that these various systems are typically all connected to a common network managed by the carrier to support communication among the systems. Moreover, some or all of the components of the travel industry system 105 can communicate with other components of the security system, such as the RAE request prioritizer 227, the RAE request extractor 225, and the risk assessment handler 235.

The reservation system 223 communicates with the carrier's other systems to make passenger reservations. For example, if a passenger is a registered frequent flier with the carrier, the reservation system 223 can retrieve a passenger's frequent flier data from the frequent flier system 220. The frequent flier system 220 is not limited to conventional frequent flier data and can comprise other passenger data such as passengers that have purchased a ticket in the last thirty days. The operational schedules system 217 can provide the reservation system 223 with necessary flight schedules for making reservations. If a passenger buys a ticket at the time the reservation is made, the reservation system 223 provides the passenger's reservation data to the ticketing system 215. Other systems represented in FIG. 2 are significant during later processes in the security system. For example, the aircraft cockpit component 204 can provide information and support communication if there is an incident after an aircraft is boarded. The flight operations system 206 controls the activity of the aircraft and provides instruction to the crew of the aircraft. These are just some of the representative activities that the airline's systems perform.

After the passenger makes a reservation and, generally, prior to the day of departure, the passenger is scored by the risk assessment engine 120. The scoring process begins with the airline's systems assembling a request to send to the risk assessment engine 120. An RAE request prioritizer 227 is responsible for assessing the priority of a request and flagging the request with a priority indicator. Prioritizing the requests allows for real-time response performance required for day of departure activity. For example, a passenger may make a reservation and purchase a ticket on the day of travel. Also, a passenger score calculated prior to the day of travel may need to be updated with a follow-up request to the risk assessment engine 120. The RAE request prioritizer 227 assigns a higher priority to activity occurring on the day of departure and a lower priority to advance bookings. The TSA can also adjust the rules the RAE request prioritizer uses for assigning priority.

Once the requests are prioritized, the RAE request extractor 225 gathers the required data for forwarding to the risk assessment engine 120 with the request. The RAE request extractor can collect data from the reservation system 223, the ticketing system 215, the operational schedules system 217, the frequent flier system 220, the departure control system 210, the baggage control system 212, and the crew scheduling component 203. The systems other than the crew scheduling component 203, generally provide information about the passenger and her itinerary. The crew scheduling component 203 can provide additional information about the crew assigned to the flight that is useful in computing a risk assessment for the entire flight. If the request pertains to cargo that is being shipped on the airline, the cargo system 205 can provide data to the RAE request extractor 225. The cargo system 205 contains a record of all cargo that is to be shipped on the airline and can maintain a list of shippers that are pre-approved.

The human resources system 207 contains airline employee data. The human resources system 207 serves as the system of record for the employment status of an employee. The human resources system 207 also works with the employee access control system 270; the authentication system 125, and the registered worker program 237, to control employee access to secure travel areas. For example, if an employee is fired, the human resources system 207 can notify the registered worker program 237 and the employee access control system 270 so that the person can no longer access secure travel areas. When employees are traveling, the employee access control system 270 can supply employee data to the risk assessment engine 120 for calculating a risk score.

Typically, the RAE request extractor's message structure for collecting and storing data is independent from the airline's method for managing data. Decoupling the RAE request extractor's storage format from that of the native airline systems reduces the likelihood that changes in one system will propagate to the other. In other words, it is advantageous to maintain uniformity in the format of data received and sent from the risk assessment engine 120 so that it can communicate with a variety of systems across the travel industry.

The RAE request transformer 230 works with the RAE request extractor 225 to transform the airline data to a uniform format for the risk assessment engine 120. The RAE request transformer provides a bridge between the unique systems of a carrier, for example, and the standard systems that comprise the rest of the security architecture. Transformation techniques can include reformatting, substitution of airline specific codes with standard codes, data restructuring, and decomposition of itinerary data to the passenger-leg level. In this exemplary embodiment, the various travel industry systems 105 that supply data to the risk assessment engine 120 use an RAE request transformer so that all data is submitted in the same format. Although not all travel industry systems 105 will have the same data content, the standard format will facilitate uniform risk calculations that can be used across the industry. Standardizing the data sent from the various travel industry systems 105 also simplifies the design and construction of the other components of the security architecture.

The risk assessment trigger system 233 controls when and how often requests are sent to the risk assessment engine 120. The risk assessment trigger system 233 comprises rules for deciding when to send a request to the risk assessment engine 120 and a software module for applying the rules. One example of a decision governed by the rules is whether to send a request to the risk assessment engine 120 or to use a previously determined score stored in the airline RAE data cache 255. Another example is whether to distribute a score received from the risk assessment engine 120 to the departure control system 210, or to simply store the score in the airline RAE data cache 255. The risk assessment trigger system 233 works with the airline risk assessment handler 235 to control the flow of data and requests to and from the airline systems.

The risk assessment engine 120 receives requests from the airline risk assessment handler 235 and a score is computed as described above in connection with FIG. 1. If a request indicates that the person is enrolled in a registered program, the risk assessment engine 120 can access the registered traveler/worker system 237 and retrieve the person's record for faster assessment. The registered traveler/worker system 237 can include a voluntary program whereby people submit background information and a biometric sample to expedite passage through the security systems. The registered traveler/worker system 237 also can share data with the authentication system 125 and the travel industry systems 105. The way in which the registered traveler/worker system 237 is implemented may depend on government or security regulations. For example, in one embodiment the registered person may still be subject to the same screening procedures as other persons. In another embodiment, the registered person may be exempted from certain screening procedures. Regardless of how the registered traveler/worker system 237 is implemented, it enhances the entire security system by providing more comprehensive and accurate data to the risk assessment engine 120.

When a score is computed for a particular request, the risk assessment engine 120 stores the request and the score in the RAE results operational data store (ODS) 240. The RAE results ODS 240 provides rapid access to risk assessment records for updating as the time of departure approaches. The risk assessment engine also utilizes a data warehouse 242 for long term storage and analysis of scores. Data stored in the data warehouse 242 can be used to detect trends and improve the security processes.

The terminal monitoring interfaces 135 can receive the computed score as well as other real-time data from the communications controller 115. Airlines typically have their own security personnel that can utilize the airline security interface 265. Airline security personnel can receive information about high risk people through the airline security interface 265 and collaborate with the law enforcement personnel to make decisions about whether to allow passengers to board an aircraft. Law enforcement personnel and airport security personnel can receive similar information about high risk people with their respective interfaces. The interfaces are coupled together to indicate that the different groups of personnel typically work together in making security decisions. In one embodiment, the terminal monitoring interfaces 135 can be the same software application with different configurations for each group of personnel. Using the same software application for each interface facilitates future updating of the interfaces. The risk assessment engine 120 can also send scores to the investigation workbenches 245. Security personnel use the investigation workbenches 245 to conduct follow-up searches and investigation of persons or items with a score indicating a high potential for a threat.

On the day of travel, the departure control system 210 manages passenger departure activities including check-in, boarding pass issuance, boarding, and standby processing. Check-in and boarding are critical steps in implementing security because they are typically the first and last points of contact, respectively, with the passenger. Before a passenger checks in with the airline, the departure control system 210 receives a passenger's reservation from the reservation system 223 and retrieves the passenger's score, previously calculated by the risk assessment engine 120, from the airline RAE data cache 255 for use during check-in. The RAE data cache 255 allows for quick retrieval of passenger scores as needed by the airline on the day of departure. In one embodiment, the departure control system 210 and the reservation system 223 are integrated so that the data in each is synchronized. In non-integrated systems where the passenger data is not synchronized, the reservation system 223 typically passes a “snapshot” of the passenger's data to the departure control system 210.

The departure control system 210 also communicates with the baggage control system 212. If the passenger is checking baggage, the passenger's score is associated with her baggage. The baggage control system 212 can comprise a variety of scanning devices as well as manual examinations and searches. The baggage control system 212 tracks the flow of baggage from the time the baggage is checked in until it is retrieved at the passenger's destination. Both the baggage control system 212 and the departure control system 210 can adjust the level of security scrutiny based on the passenger's score. In one embodiment, baggage processes can be performed by a third party hired by an airline. In such a situation the baggage control system of the third party and the departure control system 210 can communicate. Alternatively, an independent risk assessment handler can communicate directly with the third party's baggage control system. The departure control system 210 is also interactive in that it can initiate updates to the passenger's risk assessment in real-time and receive instructions from security personnel on how to manage particular passengers. If the passenger is able to check in properly, the departure control system 210 will update the passenger's data to reflect the check-in and the passenger's data will be forwarded to the passenger authentication system 273 and the security checkpoint system 130.

Exemplary Baggage Handling System

The foregoing embodiment describes a baggage handling system that uses radio frequency identification tags to track baggage. In alternative embodiments of the invention, other tracking methods can be employed, such as bar code scanning technology. A representative operating environment for baggage handling services conducted by a transportation service provider, such as an airline, typically uses a baggage control system 212 comprising a host computer, workstations operated by gate agents, customer service agents, and cargo handlers at an airport, and one or more databases, such as flight information, passenger information and baggage information databases, each coupled to a distributed computer network. Printers at airport passenger or baggage check-in areas can insert information within a radio frequency (RF)-enabled chip on a bag tag and print identifying information onto the tag. In turn, the enabled RFID tag is attached to the baggage item and forwarded to the baggage sorting system for distribution to a gate for loading aboard a selected aircraft. To support baggage tracking and sorting operations, RF scanner systems can be deployed throughout the airport and on-board aircraft to assist the collection of baggage-related information from RFID tags connected to the baggage items. In addition, wireless or wired handheld RF scanner systems can be used by ramp employees in connection with baggage loading or unloading operations. The RF scanner systems are coupled to the distributed computer network, either directly or indirectly, for communication of the detected baggage-related information to the workstations and/or the host computer.

An RFID-enabled chip embedded within a baggage tag, as described in more detail below, stores identifying information about a baggage item associated with that tag. In response to an interrogation signal by an RF scanner system, the RFID tag for a baggage item transmits RFID-encoded information for reception by the RF scanner system proximate to the tagged baggage item. The RF scanner system can communicate the RFID-encoded information to the host computer or a workstation via a direct or indirect communications link to the distributed computer network. RF scanner systems are typically deployed in the baggage handling and sorting locations of an airport, can be mounted on board aircraft, and can be implemented as wireless or wired handheld scanners.

Baggage-related information can be maintained in a structured baggage information database that stores records comprising baggage identifiers, flight segments, risk scores, and “bag last seen” information for passengers serviced by the airline. This database can support the analysis of present and past information about RFID-tagged baggage items handled by the air line on behalf of its passengers.

Using “bag last seen” information communicated by RF scanners, a computer coupled to the distribution network can identify the location (or mislocation) of a baggage item having an RFID tag based on the identifier for the bag and the location of the RF scanner that last detected the tagged baggage. In addition, an RF scanner mounted on board an aircraft or handled by ramp personnel can assist a determination of whether to accept or deny the loading of a tagged baggage item onto the aircraft. The baggage identifying information transmitted by the aircraft-mounted RF scanner can be compared to the baggage inventory for the aircraft and, in the event of a match failure, an alert can be communicated to the gate to prevent loading of the associated bag onto the aircraft. Baggage mislocation information can be distributed by the host computer to provide expedited notice of a mishandling event to a customer service agent, a down-line baggage service officer or the affected passenger. Significantly, the “bag last seen” information collected from an RFID-tagged baggage item allows an airline to proactively respond to a bag mishandling event by rerouting the baggage in response to an automated determination that the bag is at present in the wrong location.

Method for Determining Whether to Accept Baggage onto an Aircraft Based on RFID Tag Information Collected by an RF Scanner Mounted on the Aircraft

The baggage control system 212 can decide whether to accept a baggage item tagged with a Radio Frequency Identification (RFID) tag for loading onto an aircraft based on a comparison of a scanned identifier for the bag and the baggage inventory for aircraft. The following description provides an illustration of the exemplary tasks completed by an automated decision-making process for baggage handling operations for the representative operating environment of an airline.

Task 1

An RF-enabled chip is embedded within the bagtag during the tag manufacturing process. The chip is a transmitter, otherwise described as an emitter, that can transmit encoded information when interrogated by an RF source, such as an RF scanner. The manufacturer of the RF-enabled tag, often called an RF identification chip or RFID chip, typically supplies the tag to a transportation service provider, such as an airline, in support of baggage handling and identification operations conducted by the transportation service provider.

For example, U.S. Pat. No. 6,027,027 describes a representative example of a baggage or luggage tag containing an RF-enabled integrated circuit. The '027 patent describes a low-cost RFID tag for attaching to and identifying objects such as, for example, a passenger's luggage. The tag can be programmed to contain information such as the origin, destination, and name of a passenger accompanying the luggage. This information is typically programmed into the tag at the time when the customer checks his or her luggage at a terminal. The tag includes an integrated circuit with all radio and data functions incorporated onto this integrated circuit, and an antenna for radio communication. The integrated circuit in the tag is suitably powered from the incident radio frequency energy provided by a interrogator while the tag is located in the radiation pattern of this interrogator. The luggage tag is assembled inexpensively by packaging the integrated circuit between paper or plastic substrates on which printed identifying information is also added at the point of check-in at the terminal. Also, a wire loop antenna may be placed between the substrates such that it contacts the integrated circuit at two points, for forming a complete electrical circuit.

Task 2

During baggage check-in at the airline, bagtag information such as the customer's name, flight information and a numeric baggage indicator is provided to a bagtag printer during the customer check-in process. The RF module of the bagtag printer encodes the embedded RF-enabled chip of the bagtag with sufficient information to provide the bag associated with that bagtag with a unique identity. For example, the RFID chip can be encoded with a unique identifier. The printer can then print the tag for subsequent attachment to the baggage item. The printed tag can include printed identifying information typically displayed by a conventional baggage tag, such as passenger name, destination, flight information, and the identifier.

As a representative example of “smart label” printer technology, U.S. Pat. No. 6,246,326 describes a performance optimized smart label printer that enables the expedited programming of the RFID tag component of the smart label so that delays due to the unequal time between printing the exterior of the smart label and encoding the smart label are avoided. The smart label printing system comprises a thermal printing unit to print the exterior of the smart label as well as an RF driver to program the RFID tag embedded inside the smart label. The '326 patent describes methods to increase overall throughput speed of the smart label, including prioritizing RFID tag data over exterior printing data in a RAM, compressing RFID tag data sent from a host computer, and loading fixed and regularly varying data.

Prior to distributing the bagtag for attachment to the associated bag, the printer's RF module preferably tests the embedded RFID chip to confirm an accurate assignment of a unique identity to the bagtag. If this verification test fails, the printer will reject the bagtag. If the RF encoding process is correct, the bagtag is issued for attachment to the baggage. At the time of issuance, the printer provides the host computer with a “bag last seen” message via a distributed computer network. This “bag last seen” message, as issued by the printer, begins a tracking process for the baggage as it is transported from the check-in location to its ultimate delivery point, in this case, the aircraft assigned to transport the passenger associated with that baggage item.

The host computer can collect identifying information and “bag last seen” location information for each baggage item having an enabled RFID in response to messages transmitted by the printer, baggage sorting devices at the airport, and gate-based workstations. For a particular bag having an enabled RFID tag, the host computer typically associates this information with a passenger record for a flight carrying that passenger. In this manner, the host computer can track the last known location for a baggage item for a passenger on a particular flight and support baggage handling operations at departure and destination airports.

The collected baggage-related information can be maintained in a structured baggage database that stores records comprising baggage identifiers, flight segments, and “bag last seen” information for passengers serviced by the air line. Each record in the structured database can include text strings related to baggage identifying and handling information and passenger and flight information commonly available in a corresponding passenger name record (PNR). This structured baggage database can be connected to the distributed computer network for access by the host computer and a variety of workstations. The airline can use this database to access both present and past information about RFID-tagged baggage items handled by the air line on behalf of its passengers. For example, the baggage records maintained by this structured database can support an analysis of baggage mishandling events and trends for selected flights, destinations, and time frames and targeted analysis of baggage-related information for specific passengers and tagged bags.

Task 3

Upon completing the baggage check-in process, baggage with an RF-enabled bagtag is sorted at the airport for distribution to a gate assigned to the passenger's aircraft. The RF-enabled bagtag is “read” by one or more RF scanner systems during sort processes at the airport. In response to scanning an RF-enabled bagtag, the transmitter of the bagtag transmits the unique identifier assigned to that bagtag for reception by the RF scanner system. In turn, the RF scanner system can send this information to a host computer via a distributed computer network to provide “bag last seen” data to a host computer system. The “bag last seen” information typically includes the unique identifier assigned to the bagtag and the identification or location of the RF scanner system. This communication of “bag last seen” data allows the host computer to track the location of tagged baggage processed by airport sorting systems based on RF scanner system locations. This tracking assists in assuring all security processes are utilized to their fullest extent by targeting processes which are not in full use and by sending baggage to such sorting and distribution devices.

Task 4

Upon arrival at the gate, the aircraft can be connected to a local computer network via a wired and/or wireless communications link that supports data communications between aircraft systems, a workstation at the gate and the host computer. The workstation is typically connected to the host computer via a distributed computer network and the aircraft is typically connected to the workstation at the gate via the communications link. For a representative implementation, each gate includes a workstation, connected to the distributed computer network, to enable communications with an aircraft at the gate and the host computer.

Prior to beginning the baggage loading process, an agent at the gate can use a workstation to issue a request to the host computer to download flight-specific load information to the workstation via the local network. In the alternative, the workstation can subscribe to receive this flight information from the host computer and thereafter receive such information via the distributed computer network without manual intervention. The flight-specific information typically includes information for baggage to be loaded on the aircraft, including each identifier for the bagtags associated with such baggage items.

An RF scanner system is preferably mounted on the aircraft to support the scanning of each bag as it is loaded onto the aircraft. For example, one or more antennas of an RF scanner system can be mounted in the aircraft doorway to detect RF-encoded bagtag information as baggage is loaded onto the aircraft through the doorway. Each antenna is coupled to RF scanner system controls that are typically wired within the aircraft to support communications and power functions. The onboard RF scanner system is then enabled to communicate with a ground-based workstation computer through the use of an RF link or a hardwired cable.

In response to the scanning of a bagtag, at the time of loading tagged baggage or a container containing tagged baggage onto the aircraft, the RF scanner system mounted on the aircraft receives the unique identifier for each bagtag. In turn, the RF scanner system forwards the identifying information for the scanned bagtag, including the bag identifier, via the data communications link to the workstation at the gate for comparison to the aircraft baggage information obtained from the host computer.

For an alternative embodiment, in the event that carry-on luggage is tagged with RFID baggage tags, then RF scanner systems can be deployed at passenger collection points, such as gates at an airport, to scan carry-on luggage prior to the boarding of a passenger on an aircraft. Also, RF scanner systems can be used at baggage claim areas of an airport to collect information about the location of tagged baggage items delivered to a destination airport and routed to a selected baggage claim area.

Task 5

The gate workstation can automatically determine whether to reject or to accept a tagged bag, while the bag remains positioned proximate to the aircraft door, based on a comparison of the scanned bagtag information for that bag to the aircraft baggage information obtained from the host computer. For example, the identifier for the scanned bagtag can be compared to baggage information for all bags checked for loading onto the aircraft. In the absence of a match, the workstation can decide to reject the bag associated with the scanned bagtag for continued loading onto the aircraft.

For a bag reject decision, the workstation can send an advisory message to the aircraft for presentation to the baggage handling crew at the aircraft. For example, the aircraft can include an advisory system, such as a siren or flashing lights, which is activated upon receipt of a bag reject decision. In response to an audible or visual advisory, the baggage handling crew can take the appropriate actions to prevent further loading of a suspect bag at the aircraft doorway.

In contrast, for a bag accept decision, there is no requirement for the workstation to communicate with the aircraft advisory system. In the absence of an advisory alert, the baggage handling crew permits the completion of the loading operation for the scanned bag. In the alternative, the workstation can send a bag accept advisory message to the aircraft to alert the baggage handling crew to permit the continued loading of the scanned bag onto the aircraft.

The workstation automatically collects the scanned baggage information for each RFID-tagged bag loaded onto the aircraft. In turn, the workstation can send this scanned baggage information to the host computer via the distributed computer network for reconciliation with passenger records maintained for that flight. This information, collected at an aircraft while parked at its assigned gate, allows the host computer to match baggage and passenger data and to further the reconciliation process for a particular flight.

Task 6

Upon completion of loading and security check tasks, the agent utilizes the workstation to verify that baggage loading and security procedures are complete. If complete, the agent can then prepare the aircraft for departure from the gate.

Enterprise Baggage Handling Services Supported by RFID Tags

Down-Line Station Operations

A baggage service office (BSO) at either a destination or a departure airport can access the baggage-related information collected by the host computer for passengers on a selected flight to support baggage handling operations. For example, a workstation at the destination BSO, typically called the down-line station, can receive baggage-related information for a selected incoming flight based on an electronic communication with the host computer. The BSO workstation can process this information and determine that a baggage item for a passenger on that flight remains at the departure airport or is in transit to the destination airport on board another flight. The passenger records for the flight, as maintained by the host computer, provide an inventory of baggage loaded onto the aircraft at the departure airport based on “bag last seen” information for RFID-tagged baggage items. This inventory can be supplemented with baggage mishandling information, typically “bag last seen” location and identifier, for baggage items that were scheduled for loading, but not actually loaded, onto the aircraft.

As up-to-date baggage identification and location information is available for a particular flight at departure time, the host computer can send an advisory message to a destination BSO that certain baggage items for a passenger on a particular flight remain at the departure airport rather than in transport by an inbound aircraft carrying that passenger. In response to this message, the BSO workstation can automatically prepare a baggage handling claim for that passenger, in advance of the passenger's arrival to the destination airport, to support expedited handling of the baggage claim for the mishandled baggage items. This automates a baggage claim service for a mishandled baggage item that today is manually completed by a passenger contact and interview session at the BSO.

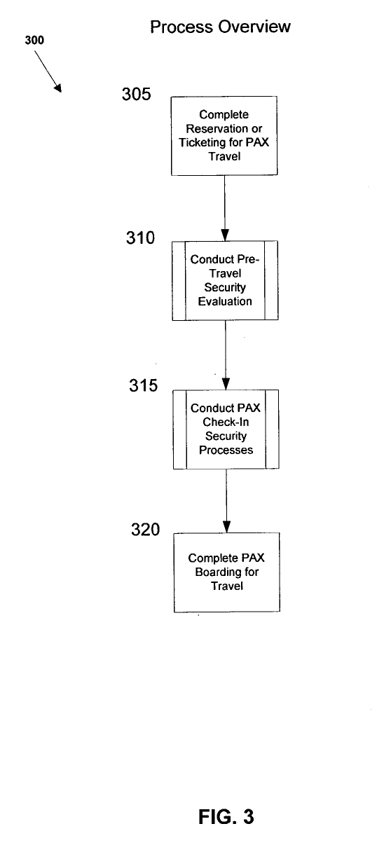

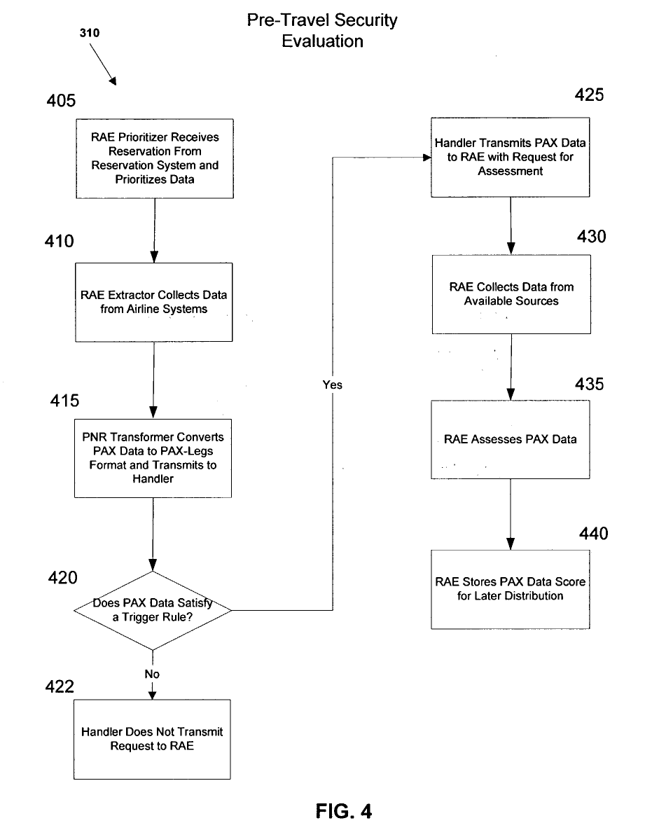

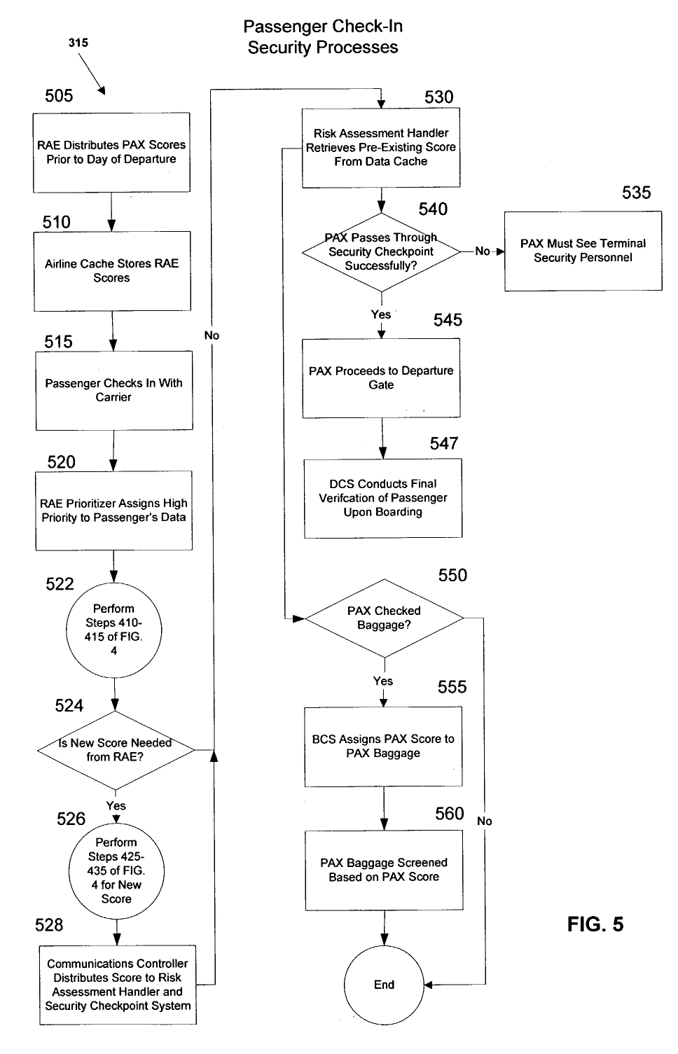

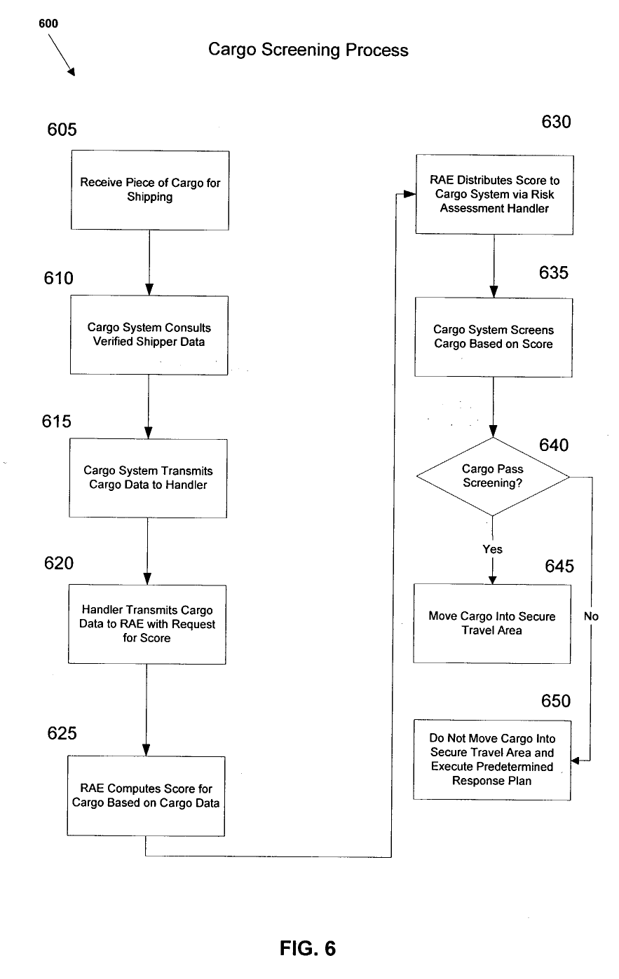

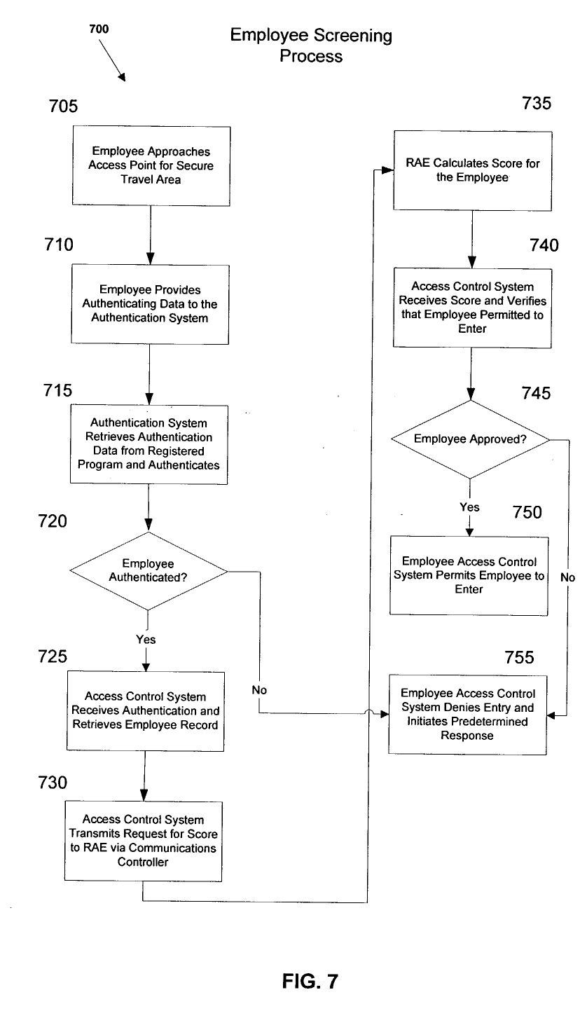

The remaining figures describe exemplary processes for implementing the components described in connection with FIGS. 1 and 2. Referring to FIG. 3, an exemplary process overview 300 is illustrated for implementing the security system in accordance with one embodiment of the present invention. Process 300 gives a high-level illustration of the security process for a passenger. This process is described in greater detail in FIGS. 4 and 5. Other embodiments of the invention are illustrated for cargo and employee screening in FIGS. 6 and 7. The exemplary processes described in connection with FIGS. 3-7 relate to an embodiment of the invention in the airline industry. However, it should be apparent to those skilled in the art that these processes can easily be adapted to alternate embodiments of the invention in other travel industries.

Referring to step 305 of process 300, a passenger (“PAX”) begins by making a travel reservation or receiving a ticket for travel with an air carrier. A passenger typically makes a reservation with the reservation system 223 in advance of the day of travel. The ticketing system 215 may issue a ticket for the passenger at the time the reservation is made or at some subsequent date. At the time the passenger makes the reservation or ticketing, he or she will submit certain identifying information. If the passenger is registered with the carrier, the frequent flier system 220 may contain additional identifying information about the passenger. Alternatively, the traveler may be registered independently with the government or an independent service that maintains a registered traveler program.

Step 310 of process 300 represents the security evaluation that takes place prior to the passenger checking in at the time of travel. Generally, the pre-travel security evaluation step 310 involves the collection of passenger data by the risk assessment handler 235 and the transfer of that data to the risk assessment engine 120. The passenger data collected by the risk assessment handler 235 typically includes required identifying information from the reservation system 223 and the itinerary information. The risk assessment engine 120 calculates a score for the passenger that indicates the potential risk that passenger represents. The score is then stored in the assessment storage device 140 for later use in managing security processes at the time the passenger is traveling. The processes represented by step 310 are described in greater detail in FIG. 4.

Step 315 of process 300 represents the passenger check-in security processes at the time of the passenger's travel. Prior to the passenger checking in, the score computed by the risk assessment engine 120 will be distributed to a number of the systems represented in FIG. 2 for use in managing the security processes during the passenger's check-in. The check-in security processes typically include physical authentication of the passenger, as well as screening of the passenger and passenger's baggage. These processes will be described in greater detail in connection with FIG. 5.

Finally, assuming the passenger successfully checks in, the passenger may proceed to boarding for travel in step 320 of process 300. Only passengers that have satisfied the security processes will be permitted into the secure travel system. If a passenger exits the secure travel system, they will have to resubmit to the security processes before being permitted to re-enter the secure travel system.

FIG. 4 illustrates an exemplary process 310 for conducting a pre-travel security evaluation after booking a flight as illustrated in step 305. In step 405, the RAE request prioritizer 227 prioritizes passengers for scoring by the risk assessment engine 120. The RAE request prioritizer 227 takes passenger data from the carrier's reservation system 223, ticketing system 215, and/or frequent flier system 220 to include in the request for the risk assessment engine 120. The RAE request prioritizer 227 prioritizes passenger data according to the date of travel. For example, a passenger that purchases a ticket on the same day of travel will have their data pushed to the front of the queue for an immediate assessment by the risk assessment engine 120. Also, updating of security scores during the check-in process are typically given a high priority. In some instances, the risk assessment handler can receive a high priority response without being initiated by a request, such as when someone is added to a watch list. Advance bookings are typically given a low priority.

In step 410, the RAE request extractor 225 collects additional data from other airline systems, such as the departure control system 210 and the baggage control system 212, for forwarding to the risk assessment engine 120. Operational schedule data is retrieved from the operational schedules system 217 for decomposing travel segments into legs as part of the data standardization process. The message structure used by the RAE request extractor 225 to store the aggregated data is independent from the way in which airline systems manage data. Decoupling the extractor's storage format from that of the native airline systems reduces the likelihood that changes to the native systems will propagate to the security system.

In step 415, the RAE request transformer 230 receives the collected data from the RAE request extractor 225 and transforms it into a uniform format for use by the risk assessment engine 120. The RAE request transformer 230 places all data, regardless of its origin from across the travel industry, in the same format for use by the risk assessment engine. The transformation processes may also require manipulation of data in certain data fields. Once the passenger data is in a standardized format, the risk assessment handler 235 consults the risk assessment trigger rules 233 to determine whether to send a request to the risk assessment engine 120. For example, a score may have been previously calculated and stored in the RAE data cache 255 eliminating the need to send another request for a score calculation. Alternatively, if the previously calculated score is dated and new data is available for a person, the risk assessment handler 235 can transmit another request to the risk assessment engine 120. If a trigger rule is satisfied, in step 425 the risk assessment handler 235 transmits a request with the standardized passenger data to the risk assessment engine 120.

A communications controller 115 can be used to manage the flow of requests and data going to and coming from the risk assessment engine 120. In step 430, the risk assessment engine 120 takes the passenger data it receives from the airline and collects other data corresponding to the passenger from other data sources. The other data sources supplying information to the risk assessment engine 120 can include law enforcement databases, government databases, and commercial credit services. The risk assessment engine then uses a calculation to quantify the potential threat that the passenger presents based on all the collected data. A variety of variables can be used to perform this calculation and they are continually modified and adjusted for more accurate assessments. Although the algorithms for performing the calculations are confidential, an example of a simplified risk calculation is the one performed by the CAPPS system discussed above. In step 440, the risk assessment engine 120 stores the calculated score in the RAE results ODS 240 for future distribution, comparison, and refinement. Depending on different timing rules that can be adjusted, scores can also be stored in the RAE data cache 255 and other travel industry systems.

The pre-travel security evaluation process 310 is merely one example of how the security invention can be implemented in the airline industry. In an alternate embodiment, a person may enroll with a registered traveler program that indicates they have previously satisfied certain security criteria. The data stored in a registered traveler program 237 would typically be coupled to the risk assessment engine 120. People enrolled with the registered traveler program would likely still have a risk assessment score calculated, however, the risk assessment calculation could be greatly simplified. Moreover, the registered traveler program would likely simplify the physical authentication and security checkpoint processes that a passenger must submit to.

Referring to FIG. 5, an exemplary process 315 is illustrated for a passenger check-in security process. Exemplary process 315 represents the processes that must occur shortly before and during the passenger check-in process. In step 505, the risk assessment engine 120 distributes the passenger score to several different systems using the communications controller 115. The passenger score can be distributed to various computer interfaces used by security personnel to monitor passengers. Passengers' scores for all passengers traveling on a particular airline for one day can also be distributed to an airline data cache 255 in step 510. The airline data cache 255 serves as a temporary storage facility for passengers' scores to be used in the immediate future by the airline.

In step 515, the passenger checks in with the carrier's departure control system 210 either upon arriving at the terminal or remotely using one of a variety of remote check-in systems. Because this is the day of travel for the passenger, the RAE request prioritizer 227 assigns a high priority to the passenger's data in the queue for potential risk requests in step 520. In step 522, the process 315 returns to process 310 illustrated in FIG. 4 and performs steps 410 and 415 for retrieving and transforming data to accompany a potential request for an assessment. In step 524, the risk assessment handler 235 determines whether a new security score is needed or whether the previously calculated score stored in the RAE data cache 255 is sufficient. The risk assessement handler 235 uses the trigger system rules 233 to make this determination. If the score does need to be updated, steps 425 through 435 are repeated and the risk assessment handler 235 receives a new score from the risk assessment engine 120. When the new score is returned, the communications controller 115 can distribute the score, in step 528, to the risk assessment handler 235 and various systems outside of the travel industry system 105 that use the score in performing the check-in process 315, such as the security checkpoint system 130. If the risk assessment handler 235 determines that a new score is not needed, it retrieves the pre-existing score from the RAE data cache in step 530.

The security checkpoint system 130, is one of the systems that uses the pre-existing score or the updated score. In step 540, the passenger passes through the security checkpoint system 130. The security checkpoint system comprises a series of metal detectors and other scanners for screening the passenger and her carry-on luggage. Using the score, the security checkpoint system 130 will be aware of any passengers that present a high risk. In step 540, the passenger's identity can also be authenticated using the authentication system 125 described previously.

In alternative embodiments of the present invention, the authentication system 125 and the security checkpoint system 130 can be combined into a single system that performs both functions simultaneously. If the passenger successfully passes through the security checkpoint system 130, the passenger can enter the secure travel system and proceed to the correct departure gate in step 545. Upon boarding the aircraft, the departure control system 210 can perform a final verification that the passenger is cleared for travel in step 547. In performing the final verification, the departure control system 210 can use the most current score as well as other information provided by components in the security system. The departure control system 210 can use systems such as a scanner located at the boarding gate to assist with the final verification step. If a passenger has checked baggage during the check-in process in step 550, the baggage control system 212 will assign the passenger score to the passenger's baggage in step 555. In step 560, the baggage control system 212 will screen the passenger's baggage based on the score. For example, where a passenger's score indicates a high risk, that passenger's baggage will be scrutinized more closely. Baggage screening can take a variety of forms including manual searching, scanning with devices, or a combination of both. Baggage screening typically takes place concurrently with the check-in processes illustrated in FIG. 5

An exemplary process 600 for screening cargo that is shipped within the travel system is illustrated in FIG. 6. Just as in the previous embodiments involving passengers, the cargo screening process involves the assignment of a risk assessment score to cargo that is shipped within the travel system. In step 605, a piece of cargo is received for shipping within the travel system. In step 610, the carrier's cargo system 205 consults a previously created list of verified shippers. Cargo handled by a verified shipper presents a lower risk of a threat and this will be reflected in the risk assessment for the piece of cargo.

Before introducing the cargo to the travel system, the cargo system 205 will transmit the cargo data to the risk assessment handler 235 for a risk assessment calculation. The data identifying a piece of cargo will have different content than passenger data, but will nonetheless be formatted for presenting to the risk assessment engine 120. In step 620, the risk assessment handler 235 transmits the request for an assessment with the cargo data to the risk assessment engine 120 via the communications controller 115. The risk assessment engine 120 can collect any other related data to the cargo and compute a score for the cargo based on the potential risk it presents. In step 630, the risk assessment engine 120 will distribute the cargo score, via the risk assessment handler 235, to the cargo system 205 and any other airline system that may need the information. In step 635, the cargo system 205 screens the cargo based on the score received from the risk assessment engine 120. Cargo with a score indicating a high risk will receive greater scrutiny in the screening process. In step 640, if the cargo passes the screening process, the cargo can be introduced to the secure travel system and would be loaded onto the appropriate aircraft. If the cargo does not pass the screening, it will not be moved into a secure travel area and a predetermined response can be activated by the incident response system 150 in step 650.

An exemplary process 700 for using the present invention to screen employees is illustrated in FIG. 7. In addition to the passengers, baggage and cargo that are introduced to the secure travel system, a variety of other people, generally described as employees, will also have access to the travel system. These employees can include carrier employees, security personnel, terminal employees, and vendors. The exemplary process 700 will ensure that each employee with access to the secure travel system will also be assessed for any potential risk and screened accordingly. The exemplary process 700 illustrated in FIG. 7, concerns an employee of the carrier. Those skilled in the art will recognize that the exemplary process 700 can be easily adapted to screen other types of employees. Before the employee attempts to access a secure area, the employee typically is enrolled in the registered worker program 237. The registered worker program 237 can comprise comprehensive identifying information for the employee and a biometric sample. An identifying record for the employee is also stored in the employee access control system 270.

Beginning with step 705, an employee approaches an access point for a secure travel area. In the preferred embodiment, employee access control systems 270 and authentication systems 125 are located at access points to secure travel areas. In step 710, the employee provides authenticating data to the authentication system 125. As described above, authenticating data can be presented in the form of an identification card, a smart card, and/or a biometric sample. The authentication system 215 retrieves authentication data from the registered worker program 237 and determines whether there is a match in step 715. If the employee cannot be authenticated in step 720, access is denied and the incident response system 150 initiates a predetermined response. If the employee is authenticated, the employee access control system 270 receives a positive signal from the authentication system 125 and retrieves a record for the employee.

As with many of the other components in the travel security system, the employee access control system 270 can send a request for a risk assessment to the risk assessment engine. In step 730, the employee access control system 270 transmits a request, via the communications controller 115, for an assessment with the employee's identifying information. The risk assessment engine calculates a score for the employee using the identifying data and other data associated with the employee retrieved from other sources. In one embodiment, the risk assessment engine can consult the registered worker program 237 to verify or confirm information about the employee. In step 740 the employee access control system 270 receives the computed score from the communications controller 115 and verifies that the employee is permitted to enter the secure travel area. If the employee is approved for access in step 745, the employee will be permitted to enter the secure travel system in step 750. If the employee is not approved for access, she will be denied access and a predetermined response will be initiated by the incident response system 150 in step 755.

In conclusion, the present invention, as represented in the foregoing exemplary embodiments, provides a system and method for implementing security across the travel industry. By approaching the security problem from a system-wide perspective, the present invention provides a more comprehensive and effective solution to maintaining a secure travel system. In one embodiment, a carrier can use a risk assessment score for a passenger to screen that passenger and her baggage during check-in. Other authentication and screening systems at the terminal can also use the score to select a level of security scrutiny for a passenger. In another embodiment, an employee access control system can use the score with other employee data to control the access of employees to secure areas within the travel system. In yet another embodiment, a cargo system can use the score to efficiently and effectively screen cargo being shipped in the travel system. These embodiments illustrate that using a security score in conjunction with a variety of systems that control access to the travel system provides a more effective security solution for the travel industry.

It will be appreciated that the present invention fulfills the needs of the prior art described herein and meets the above-stated objects. While there has been shown and described the preferred embodiment of the invention, it will be evident to those skilled in the art that various modifications and changes may be made thereto without departing from the spirit and the scope of the invention as set forth in the appended claims and equivalents thereof. For instance, the present invention could be used by other commercial carriers for rail and boat transportation and to support connections among different modes of air, ground, and water transportation. The invention can also be used in other environments where patrons pass through a single departure point, such as in an amusement park, a stadium, or a multiplex theater. Although the present invention has been described as operating in a distributed computing environment, it should be understood that the invention can be applied to other types of computing systems.

What is claimed is:

1. A method for implementing security in the travel industry comprising the steps of
transmitting carrier passenger data for a passenger from a carrier to a risk assessment engine managed by a party other than the carrier;
receiving a score reflecting risk for the passenger from the risk assessment engine, the score based on the carrier passenger data and data from at least one data source controlled by a party other than the carrier;
providing the score to the carrier before the passenger checks in for travel; and
using the score to control access to a secure travel area by the passenger.

2. The method of claim 1, further comprising the step of transmitting the score to security personnel.

3. The method of claim 1, further comprising the step of converting the carrier passenger data to a uniform format.

4. The method of claim 1, further comprising the step of associating the score with the passenger's baggage to adjust a level of screening for the baggage.

5. The method of claim 1, wherein the data source is one of a credit reporting service, another carrier, a government data source, and a registered person program.

6. The method of claim 1, further comprising the steps of
transmitting the score to a security checkpoint system; and
adjusting the screening for the passenger at the security checkpoint system based on the score.

7. A computer-readable medium comprising computer-executable instructions for performing the steps required in claim 1.

8. A computer-implemented method for providing security in the travel industry comprising the steps of
transmitting travel data from a travel industry system to a risk assessment engine;
receiving an assessment of risk from the risk assessment engine based on the travel data and data from at least one of a credit reporting service, a government data source, and a registered person program; and
using the assessment of risk to control access to a secure travel area.

9. The method of claim 8, wherein the travel data comprises passenger data.

10. The method of claim 8, wherein the travel data comprises cargo data.

11. The method of claim 8, wherein the travel data comprises employee data.

12. The method of claim 8, wherein the assessment of risk is associated with the travel data for a passenger when the passenger checks in.

13. The method of claim 8, wherein the format of the travel data is transformed to a standard format before being transmitted to the risk assessment engine.

14. The method of claim 8, wherein the step of using the assessment of risk further comprises directing a passenger to a particular security checkpoint.

15. The method of claim 8, wherein the step of using the assessment of risk further comprises directing a piece of cargo to a particular screening checkpoint.

16. The method of claim 8, further comprising the step of transmitting the assessment of risk to security personnel.

17. A computer-readable medium having computer-executable instructions for performing the steps recited in claim 8.

18. A computer-implemented method for providing security in the travel industry comprising the steps of
transmitting cargo data for a piece of cargo from a carrier to a risk assessment engine;
receiving a score reflecting risk for the piece of cargo from the risk assessment engine, the score based on the cargo data and data from at least one of a registered shipper program and a government data source;
providing the score to a cargo system; and
screening the piece of cargo with the cargo system based on the score.

19. The method of claim 18, further comprising the step of converting the cargo data to a standard format.

20. The method of claim 18, wherein screening the piece of cargo comprises scanning it with a scanning device.

21. The method of claim 18, wherein screening the piece of cargo comprises manually searching the piece of cargo.

22. The method of claim 18, further comprising the step of transmitting the score to security personnel.

23. A computer-readable medium having computer-executable instructions for performing the steps recited in claim 18.

24. A computer-implemented method for providing security in the travel industry comprising the steps of
transmitting employee data for an employee to a risk assessment engine;
receiving a score reflecting risk for the employee from the risk assessment engine, the score based on the employee data and data from at least one of a credit reporting service, a government data source, and a registered person program;
providing the score to a human resources system; and
using the score to control the employee's access to a secure travel area.

25. The method of claim 24, wherein the employee data is transmitted from an airline.

26. The method of claim 24, wherein the employee data is transmitted from an airport vendor.

27. The method of claim 24, further comprising the step of transmitting the score to an employee access system.

28. The method of claim 24, further comprising the step of using the score to choose an authentication process for the employee.

29. A computer-readable medium having computer-executable instructions for performing the steps recited in claim 24.

30. A computer-implemented system for providing security in the travel industry comprising:
a travel system operable for generating travel data;
a risk assessment engine operable for receiving travel data from the travel system and calculating a score reflecting risk for the travel data; and
a security checkpoint system operable for receiving the score from the risk assessment engine and using the score to control access to a secure travel area.

31. The system of claim 30, wherein the security checkpoint system comprises a physical authentication system operable for receiving the score and using the score to select an authentication method for a person associated with the travel data.

32. The system of claim 30, further comprising a monitoring interface operable for receiving the score and monitoring a person associated with the travel data.

33. The system of claim 30, wherein the travel system is operable for receiving the score and associating the score with a passenger when the passenger checks in.

34. The system of claim 30, further comprising a cargo system operable for receiving the score and adjusting a level of screening, based on the score, for a piece of cargo associated with the travel data.

35. The system of claim 30, further comprising a baggage control system operable for receiving the score and adjusting the type of screening, based on the score, for a piece of baggage associated with the travel data.

36. The system of claim 30, further comprising a data interface operable for converting the travel data to a standard format compatible with the risk assessment engine.

37. A computer-implemented method for providing security in the travel industry comprising the steps of
receiving travel data from a travel industry system;
calculating a score reflecting risk, the score based on the travel data and data from at least one data source other than the travel industry system; and
providing the score to the travel industry system for use in controlling access to a secure travel area.

38. The method of claim 37, further comprising the step of transmitting the score to security personnel.

39. The method of claim 37, wherein the data source is one of a credit reporting service, another travel industry system, a government data source, and a registered person program.

40. The method of claim 37, further comprising the steps of
transmitting the score to a security checkpoint system; and
adjusting the level of screening for a passenger at the security checkpoint system based on the score.

41. A computer-readable medium having computer-executable instructions for performing the steps recited in claim 37.
